(19) United States
(12) Patent Application Publication
(10) Pub. No.: US 2015/0170061 A1
(43) Pub. Date: Jun. 18, 2015

(54) WEB TICKETING EVENT SYSTEM

(71) Applicant: Scott J. Glosserman, Los Angeles, CA (US)

(72) Inventors: Scott J. Glosserman, West Hollywood, CA (US); Darren P. Warner, Thousand Oaks, CA (US)

(21) Appl. No.: 14/294,715

(22) Filed: Jun. 3, 2014

Related U.S. Application Data
(60) Provisional application No. 61/916,904, filed on Dec. 17, 2013.

(51) Int. Cl. G06Q 10/02; G06F 17/30; H04L 29/08

(52) U.S. Cl. CPC G06Q 10/02; H04L 67/02; G06F 17/30241

(57) ABSTRACT

A system for searching a database to determine the status of a tentative event and to facilitate the purchase of rights in the event includes (a) computer means programed for (i) searching a database containing information regarding the tentative event; and (ii) connecting a user to a purchasing agency authorized to provide rights in the event; and (b) a computer display programed to display information regarding the status of a tentative event on an interactive map wherein the location of the tentative event is displayed and the status of the tentative event is indicated by a color code.

### RELATED APPLICATION

This application claims priority from U.S. patent application Ser. No. 61/916,904, entitled “WEB TICKETING EVENT SYSTEM,” filed Dec. 17, 2013, the entirety of which is incorporated herein by reference.

### FIELD OF THE INVENTION

This invention relates generally to event ticketing systems, and more specifically to on-line systems for ticketing tentative events.

### BACKGROUND OF THE INVENTION

It is known to offer the public through the web an opportunity to purchase rights in a tentative event, such as tickets to a tentative motion picture screening. If enough people sign up, the event is put on. If not enough, it is not. Thus, screenings happen when a minimum number of people reserve tickets before a predetermined expiration date, which is called “tipping” the screening.

There are no known systems, however, which provide search capability for a database of tentative events, display the status of those tentative events in a readily reviewable and easily understood format and provide a convenient avenue of contacting a purchasing agency authorized to provide rights in the event.

### SUMMARY OF THE INVENTION

The invention provides such a system. The invention is a system for searching a database to determine the status of a tentative event and to facilitate the purchase of rights in the event, the system comprising: (a) computer means programed for (i) searching a database containing information regarding the tentative event; and (ii) connecting a user of the system to a purchasing agency authorized and adapted to provide rights in the event; and (b) a computer display device programed to receive information from the computer means regarding the status of the tentative event and to display that information in an interactive map format, wherein the location of the tentative event is displayed on a map, and the status of the tentative event is indicated by a color code.

Access to the system can be provided at a stand-alone website or can be embedded as an ASP Model or iFrame on any website.

### DRAWINGS

These and other features, aspects and advantages of the present invention will become better understood with reference to the following description, appended claims, and accompanying drawings where:

FIG. 1 is a computer screen image illustrating one feature of the invention;

FIG. 2 is a computer screen image illustrating another feature of the invention;

FIG. 3 is a computer screen image illustrating another feature of the invention;

FIG. 4 is a computer screen image illustrating another feature of the invention;

FIG. 5 is a computer screen image illustrating another feature of the invention;

FIG. 6 is a computer screen image illustrating another feature of the invention;

FIG. 7 is a computer screen image illustrating another feature of the invention; and

FIG. 8 is a computer screen image illustrating another feature of the invention.

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

### Definitions

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers, ingredients or steps.

### The Invention

The invention is a system for searching a database to determine the status of a tentative event and to facilitate the purchase of rights in the event. The system comprises computer means programed for (i) searching a database containing information regarding the tentative event; and (ii) connecting a user of the system to a purchasing agency authorized and adapted to provide rights in the event; and (b) a computer display device.

The computer means can be provided by any of the many tangible processors known in the art. Such tangible processor can be any of the wide variety of programmable computing devices presently known to the art or which are later made known to the art. Typically, the tangible processor is a programmable computer or portable communications device.

The computer display device is programed to receive information from the computer means regarding the status of the tentative event and to display that information in an interactive map format wherein the location of the tentative event is displayed on a map.

The computer display device is also programed to display the status of the tentative event on the map as indicated by a color code.

The invention can be used for almost any tentative event which can be booked. The drawings illustrate one embodiment of the invention where the invention facilitates the reserving and/or the purchasing of reservations for motion picture screenings. In a typical example of this embodiment, a screening event will be scheduled when a minimum number of people reserve tickets by pre-authorizing their credit cards (or other methods of payment) before a predetermined expiration date. The confirming of the screening event only after a minimum number of people pre-reserve tickets is called “tipping” the screening.

As illustrated in the drawings, color coded dots on an interactive map display can indicate whether a screening has tipped (green, in this example) or has not yet tipped (blue, in this example). The dots each have a given number, which corresponds to the number of screening opportunities in the geographical area covered by the dot. As the user zooms in on the map to locate a specific screening opportunity, the dots become smaller and more specific to the location of each theater within the zoomed-in location. Alternatively, the user may enter a zip code to zoom directly to that area of the map.

When the user clicks on a dot, a screening section for the movie appears to the right of the map. In the screening section, an update shows current reservations, how many additional reservations are needed to tip the screening, and the deadline for reservations. If the screening has tipped, the section shows how many seats are available, whether the screening has sold out, and the deadline for purchasing tickets. The user may then purchase or reserve tickets (depending on the screening status) through the screening page.

When a screening has not tipped, the user can reserve a ticket by pre-authorizing a credit card (or other method of payment). When a screening tips, the ticket purchase is processed immediately.

If enough people reserve tickets before the deadline, then the ticket reserve threshold is met and the screening is tipped, pending confirmation. Once confirmed, all credit card pre-authorizations are processed and the screening takes place. If the minimum number of tickets is not reserved, the screening does not take place and no one is charged. Credit cards are only charged if the screening has met the minimum number of reservations and has tipped.

If there is no screening available where the user lives, the user may 1) sign up for a notification should a screening become available near the user's location or 2) request a screening.

The interactive map can encompass an entire city, country or continent. As illustrated in detail in the drawings, the interactive map can encompass the entire world.

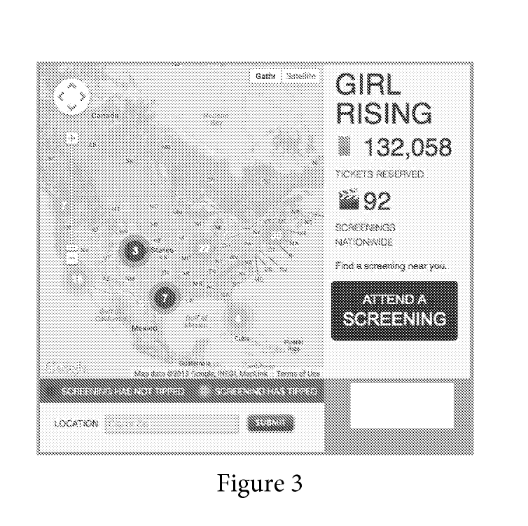

Initially, the call to action on a display screen's right vertical column is “Attend a Screening” (as in FIG. 3). Pressing this button will zoom the consumer into the area where he/she has been geo-targeted.

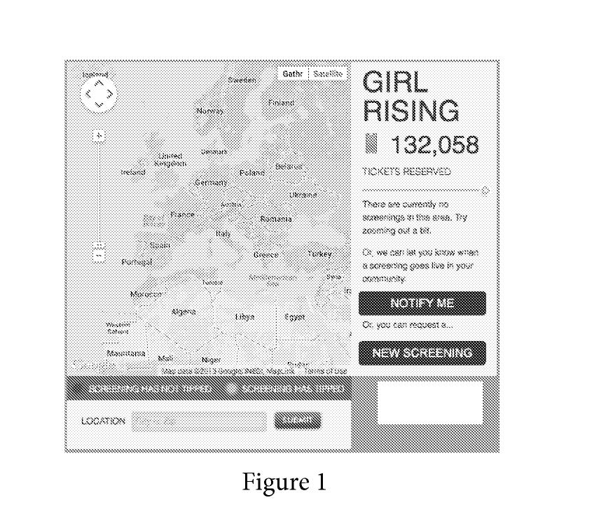

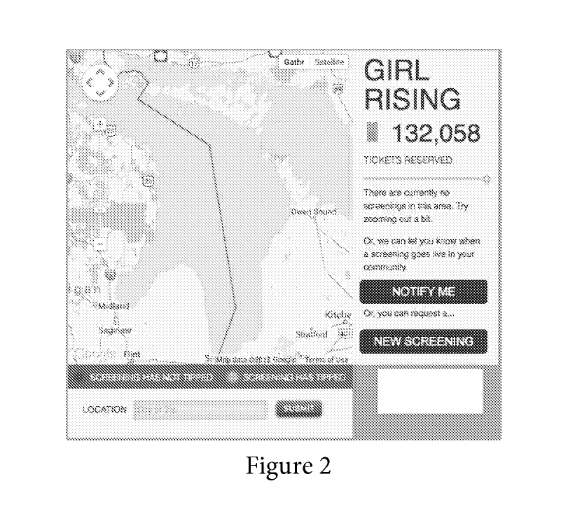

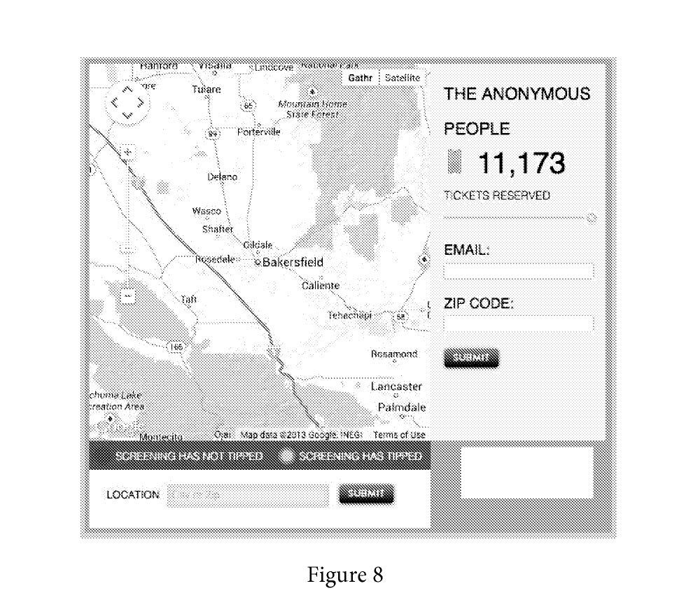

If the user zooms into an area where there are no screenings present (as in FIGS. 1 and 2), the right vertical column's call to action changes to “Notify Me” (this takes a user to a modal window site as in FIG. 8 where entering an email and zip code will allow the user to receive an alert if and when a screening gets set up in the area) and to “New Screening” (this take a user to a screening site request form).

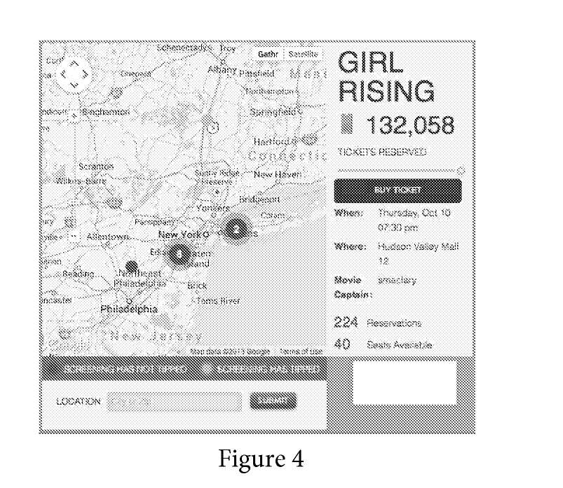

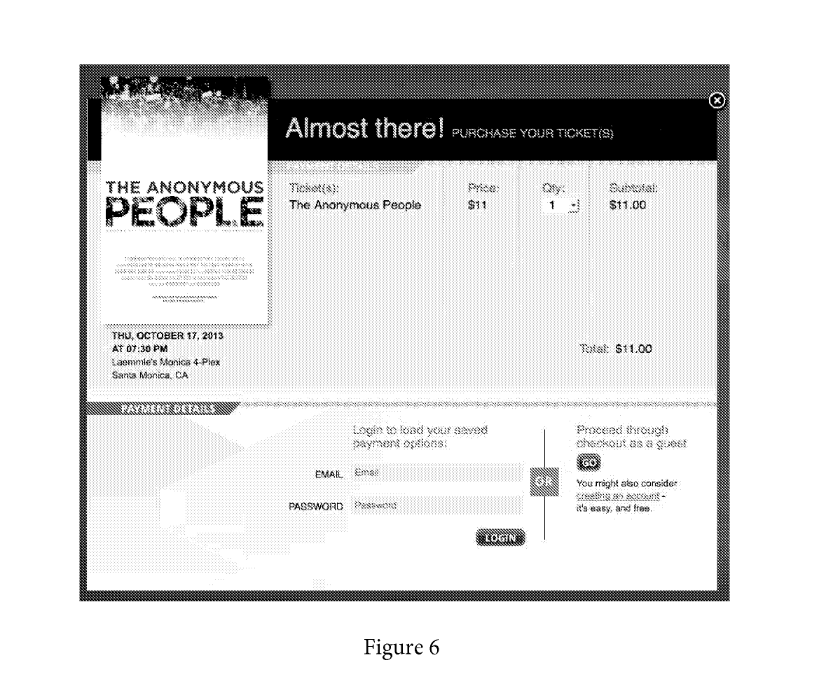

When the user clicks on a green dot, the right vertical column changes to display the screening details, amount of tickets purchased and available, and a button to “Purchase Your Ticket(s) (as in FIG. 4).” (Clicking on this takes a user to a shopping cart site as in FIG. 6.)

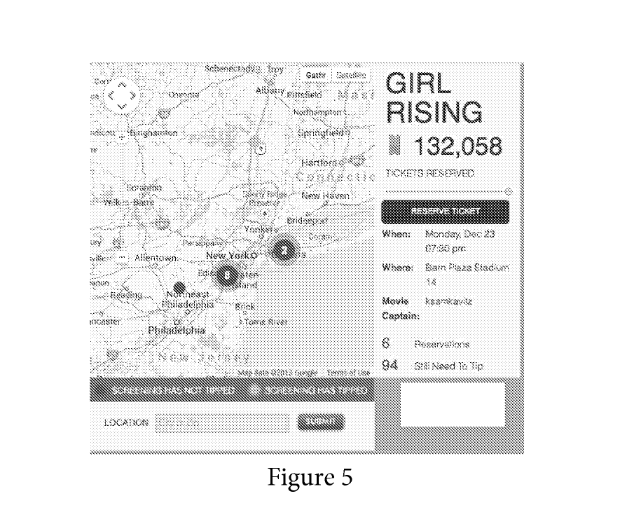

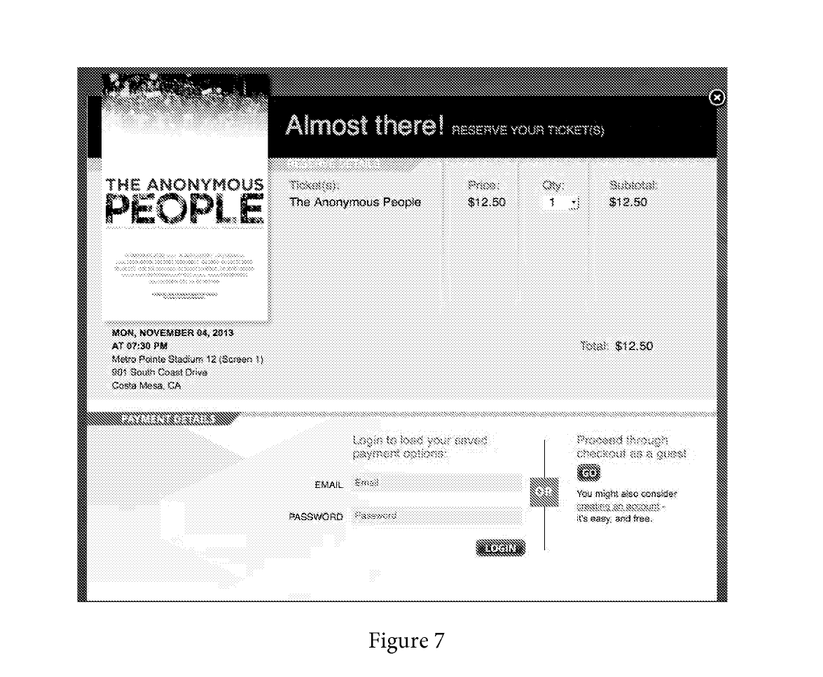

When the user clicks on a blue dot, the right vertical column changes to display the screening details (as in FIG. 4)—including displaying a Tickets Reserved/Available button and a Reserve a Ticket button (as in FIG. 5). (Clicking the Reserve a Ticket button takes the user to the shopping cart site, as in FIG. 7.)

The invention can be used for music concerts, stand-up comedy, plays and book tours (e.g., for self-published authors using the pre-sale of books to tip an in-store reading/signing event). The invention can also be used for tentative sales events. For example, a clothing store might offer $10 T-shirts for $5 if enough people are interested.

Additionally, the invention can be used to aggregate buying power to negotiate reduced price service contracts (e.g., to negotiate better health care rates). An insurer can use the invention to offer reduced rates. The invention can also be adapted to handle one-off stores.

Also, the invention can be effectively employed on the websites of content owners and their affiliates, social media websites and the website of a master user.

Still further, the invention can be adapted to handle retails chains' entire store footprint. For example: A major retailer can provide its store databases to a service provider using the invention. The service provider then imports the databases into a database at the “back end” of the invention system and creates a footprint, populating an interactive map with some or all of the retailer's locations. This interactive map can be embedded on the retailer's websites, its affiliates' web sites, used in social media, etc. The retailer can run a national social media (and offline) campaign—(e.g. “Reserve a voucher for a free meal combination at a franchise near you. However, in order to get the free combination meal, 1000 people must also reserve the voucher, so tell your friends!”). In this way a national brand can run a national campaign, but can also support its local stores and franchisees. If only a fraction of the overall footprint tips, that is fine. Consumers redeem their vouchers in the store. The store managers mail the vouchers to the service provider and the service provider provides the data on the conversion to the retailer. This business method can be used for free offers such as the one described immediately above, or it can be used for paid offers, such as the one described further above.

Having thus described the invention, it should be apparent that numerous structural modifications and adaptations may be resorted to without departing from the scope and fair meaning of the instant invention as set forth herein above and described herein below by the claims.

What is claimed is:

1. A system for searching a database to determine the status of a tentative event and to facilitate the purchase of rights in the event, the system comprising:
a) computer means programed for (i) searching a database containing information regarding the tentative event; and (ii) connecting a user of the system to a purchasing agency authorized and adapted to provide rights in the event; and
b) a computer display device programed to receive information from the computer means regarding the status of the tentative event and to display that information in an interactive map format, wherein the location of the tentative event is displayed on a map, and the status of the tentative event is indicated by a color code.

2. The system of claim 1 wherein the tentative event is an entertainment event.

3. The system of claim 1 wherein the tentative event is a motion picture screening.

4. The system of claim 1 wherein the tentative event is a music concert.

5. The system of claim 1 wherein the tentative event is a sale of goods.

6. The system of claim 1 wherein the tentative event is a sale of services.

7. The system of claim 1 wherein the computer means is programed so that the interactive map can display an entire city.

8. The system of claim 1 wherein the computer means is programed so that the interactive map can display an entire country.

9. The system of claim 1 wherein the computer means is programed so that the interactive map can display an entire continent.

10. The system of claim 1 wherein the computer means is programed so that the interactive map can display the entire world.

11. The system of claim 1 wherein the computer means is programed so that the interactive map can zoom in and zoom out.

12. The system of claim 1 wherein the computer means is programed so that the status of the tentative event indicated by a color code indicates whether the event has tipped, not tipped or sold out.

13. The system of claim 1 wherein the computer means is programed so that the status of the tentative event includes the number of reservations received for the event and the number of additional reservations required for the event to tip.

14. The system of claim 1 wherein the computer means is programed so that the status of the tentative event includes the number of reservations which may be received for the event before the event sells out.

15. The system of claim 1 wherein the computer means is programed to provide the ability to request notification of the tipping of the event.

16. The system of claim 1 wherein the computer means is programed to provide the ability to request a different event.
